(19) United States
(12) Patent Application Publication
(10) Pub. No.: US 2025/0223890 A1
(43) Pub. Date: Jul. 10, 2025

(54) SUBSEA EXPANSION JOINT

(71) Applicant: FMC Technologies, Inc., Houston, TX (US)

(72) Inventors: Matthew Faulk, Houston, TX (US); Allison Weber, Houston, TX (US)

(21) Appl. No.: 18/408,234

(22) Filed: Jan. 9, 2024

(51) Int. Cl. E21B 43/013; E21B 33/038

(52) U.S. Cl. CPC E21B 43/0135; E21B 33/038

(57) ABSTRACT

Expansion joints, jumper assemblies, and subsea connection systems for providing a linearly extendable connection between two or more subsea components. The expansion joint allows the jumper assembly to be selectively extended to provide a stroke length for connecting an end of the jumper assembly to a respective subsea component. Additionally, the expansion joint allows connections to be established over short distances where the length of the jumper does not provide suitable flexibility.

### BACKGROUND

### 1. Field

Embodiments of the present disclosure relate to an expansion joint. More specifically, embodiments of the present disclosure relate to an expansion joint for connecting one or more flowline jumper portions of a subsea system.

### 2. Related Art

Jumper assemblies are used to provide a connection between two or more subsea components within a subsea well system. For example, a jumper may be disposed between a subsea manifold and a well tree assembly to provide a removable or permanent connection between them. In some cases, the jumper may include a flexible pipe or semiflexible pipe configured to provide at least some flexibility to the jumper. However, a number of difficulties exist in the installation of the jumper assembly, especially at short distances. For example, at short distances, the flexibility of the jumper may not be sufficient to provide the stroke length to make a connection. Further, typical jumper assemblies extend into multiple planes such that the assemblies are able to be supported from the sea floor. Accordingly, transportation and lifting of the large complex jumper geometries becomes space consuming, and complex load spreading equipment may be needed to place the heavy jumper assemblies on a barge whereas a typical barge is only capable of transporting a single jumper assembly at a time. Additionally, complex jumper assemblies require sea floor support resulting in extensive surveying operations and support structures and dependence on the highly variable surface quality of the sea floor.

### SUMMARY

Embodiments of the present disclosure may solve the above-mentioned problems by providing a subsea expansion joint, jumper assembly, and subsea connection system with the capability to linearly extend to provide a stroke length for connecting to one or more ports of subsea components.

In some aspects, the techniques described herein relate to an expansion joint for connecting one or more flowline jumper portions of a subsea well system, the expansion joint including: one or more linearly slidable connectors configured to linearly adjust a length of the expansion joint, where the one or more linearly slidable connectors provide a fluid path between the one or more flowline jumper portions; at least one seal configured to provide a pressure seal within the expansion joint; and a latch device configured to lock the one or more linearly slidable connectors in place.

In some aspects, the techniques described herein relate to a jumper expansion assembly for connecting a subsea well system, the jumper expansion assembly including: a first flowline jumper portion extending longitudinally from a first subsea well system component of the subsea well system; a second flowline jumper portion extending longitudinally from a second subsea well system component of the subsea well system; an expansion joint configured to join the first flowline jumper portion and the second flowline jumper portion, the expansion joint including: a linearly slidable connector configured to linearly adjust a length of the expansion joint, wherein the linearly slidable connector provides a fluid path between the first flowline jumper portion and the second flowline jumper portion; and at least one seal configured to provide a pressure seal within the expansion joint.

In some aspects, the techniques described herein relate to a subsea well system including: a manifold; a well tree assembly; a first flowline jumper portion extending longitudinally from the manifold; a second flowline jumper portion extending longitudinally from the well tree assembly; an expansion joint configured to join the first flowline jumper portion and the second flowline jumper portion, the expansion joint including: a linearly slidable connector configured to linearly adjust a length of the expansion joint, where the linearly slidable connector provides a fluid path between the first flowline jumper portion and the second flowline jumper portion; and at least one seal configured to provide a pressure seal within the expansion joint.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, where:

FIG. 1 illustrates an exemplary flowline jumper system relating to the prior art.

FIG. 2 illustrates an exemplary subsea well system.

FIG. 3 illustrates an exemplary linearly slidable expansion joint.

FIG. 4A illustrates an exemplary expansion joint assembly in a retracted position.

FIG. 4B illustrates the exemplary expansion joint assembly in an extended position.

FIG. 5 illustrates an exemplary telescoping expansion joint.

FIG. 6 illustrates an exemplary threaded expansion joint.

FIG. 7 illustrates an exemplary method of connecting a jumper assembly.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. Therefore, the following detailed description is not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc., described in one embodiment may also be included in other embodiments but is not necessarily included. Thus, the technology can include a variety of combinations and/or integrations of the embodiments described herein.

Embodiments of the present disclosure relate to providing an expansion joint for a jumper assembly of a subsea system. The expansion joint is able to linearly extend to provide a stroke length that establishes one or more connections with subsea components.

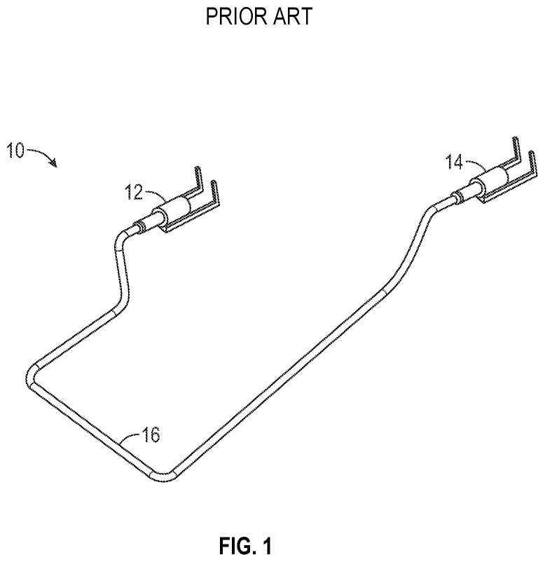

FIG. 1 illustrates an exemplary flowline jumper system 10 relating to the prior art. The flowline jumper system 10 comprises a first connection 12, flowline jumper tubing 16, and a second connection 14. The first connection 12 and the second connection 14 may be secured to the flowline jumper tubing 16 at respective ends of the flowline jumper tubing 16, as shown. The flowline jumper system 10, for example, may be used to join one or more subsea well components, such as a manifold and well tree assembly. For example, the first connection 12 may be fluidly connected to a port on a well tree assembly while the second connection 14 may be fluidly connected to a port on a manifold to thereby fluidly connect the well tree to the well tree assembly.

The flowline jumper tubing 16 may be configured to be placed directly onto the sea floor or is otherwise configured to be supported by one or more feet or other support structures placed beneath the flowline jumper tubing 16 on the sea floor. Accordingly, fabrication of the flowline jumper system 10 may involve a plurality of customized support structures, which increases the overall cost and complexity of the flowline jumper system. In many circumstances, the state of the sea floor may be unknown. Accordingly, the sea floor may have any combination of drill cuttings from previous operations, undulations, and other surface defects that complicate installation. Further, the flowline jumper tubing 16 is configured to extend into multiple distinct planes such that the flowline jumper tubing 16 is able to rest on the sea floor without tipping. Further, the flowline jumper tubing 16 may be a rigid, non-flexible tubing structure. Alternatively, in some cases, a flexible or semi-flexible tubing structure may be used.

The flowline jumper system 10 may be difficult to transport because the flowline jumper tubing 16 extends into multiple planes and, thus, occupies a relatively large amount of space. The flowline jumper tubing 16 may be oriented along multiple planes to provide a three-dimensional structure capable of resting upon the seafloor or upon a support structure placed on the sea floor. For example, the flowline jumper system 10 may be transported on a barge or other sea-fairing transportation means, and, in many cases, only a single set of flowline jumper tubing 16 may be transported at a time. Alternatively, the flowline jumper system 10 may be transported in multiple distinct parts and assembled onsite. However, the onsite assembly further contemplates installation and increases overall installation time and cost.

The flowline jumper system 10 of the prior art has a number of other difficulties, including a lack of flexibility associated with joining connection ports at short distances (i.e., between about 50 feet and about 150 feet). For example, flexible pipe assemblies provide sufficient flexibility to provide the necessary stroke length to couple ends of the jumper to ports of the subsea components at large distances, such as over 200 feet. However, for smaller distances, the length of the flexible pipe is insufficient to provide the flexibility necessary for the stroke length. Accordingly, jumpers with complex geometries may be used to provide additional length and flexibility. Alternatively, in some cases, complex means of connection and subsea assembly onsite may be used to provide stroke length.

The difficulty of providing a suitable stroke length for jumper assemblies as short distances is especially relevant for subsea components with horizontal connection ports (i.e., connection ports that are parallel to the sea floor). For example, the stroke length is oriented along the horizontal direction such that the pipe must be stroked horizontally to establish a connection. Alternatively, in the case of vertical connections (i.e., connection ports that are perpendicular to the sea floor), a vertical stroke is used to establish the connection. However, it should be understood that similar difficulties may occur even for systems with vertical connections at short distances.

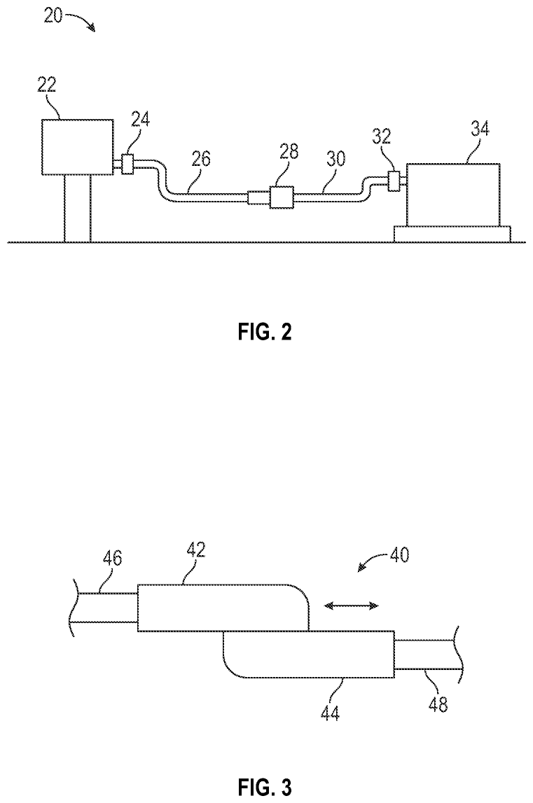

FIG. 2 illustrates an exemplary subsea well system 20 relating to some embodiments. The subsea well system 20 includes a first subsea well component 22 such as, for example, a well tree assembly, also referred to as a “Christmas” tree or X-mas tree. A first connection 24 may be connected to a fluid port of the first subsea well component 22, as shown. The first connection 24 is joined to a first flowline jumper portion 26 extending from the first subsea well component 22.

In some embodiments, the first flowline jumper portion 26 and the second flowline jumper portion 30, described in further detail below, include any combination of flexible or rigid pipe. For example, embodiments are contemplated in which the jumper assembly includes rigid pipe such that the flexibility of the pipe is minimal, and the pipe is not capable of flexing to provide a stroke length to make the first connection 24 or a second connection 32. Alternatively, in some embodiments, the first flowline jumper portion 26 and the second flowline jumper portion 30 comprise flexible pipe portions that are at least semi-flexible and capable of bending. However, the flexibility of the flexible pipe may still not be sufficient to provide the stroke length to make a connection at short distances.

The flowline jumper portion 26 is coupled at an opposite end from the first connection 24 to an expansion joint 28, as shown. The expansion joint 28 is coupled to an end of a second flowline jumper portion 30 that extends from the expansion joint 28 to a second connection 32, with the second flowline jumper portion 30 coupled to the second connection 32 at an opposite end. The second connection 32 is coupled to a fluid port of a second subsea well component 34, such as, for example, a subsea manifold assembly including any of a block manifold, pipe manifold, or another suitable form of subsea well component. It should be understood that, in some embodiments, the expansion joint 28 may include any of a variety of forms of expansion joints described herein, such as, for example, a linearly sliding expansion joint, a telescoping expansion joint, or a threaded expansion joint.

In some embodiments, the first subsea well component 22 and the second subsea well component 34 include a connection hub including a plurality of connection ports. The connection ports may include any combination of horizontal connection ports and vertical connection ports. Further, in some embodiments, connection ports may be included at any angle relative to the sea floor, such as, for example, a 30 degree angle, a 45 degree angle, a 60 degree angle, or another suitable angle from the sea floor.

In some embodiments, the expansion joint 28 is suspended over a sea floor environment, as shown. For example, the jumper assembly, including the first flowline jumper portion 26, the expansion joint 28, and the second flowline jumper portion 30 may be supported by the first subsea well component 22 and the second subsea well component 34 via the connections 24, 32 at each end such that the jumper assembly is suspended over the sea floor. Accordingly, in some such embodiments, separate supports are not used to support the expansion joint 28, and the expansion joint 28 does not rest directly on the sea floor. Accordingly, installation of the jumper assembly is simplified because the variability of the sea floor does not further complicate installation.

In some embodiments, either or both of the first connection 24 and the second connection 32 are horizontal relative to the sea floor. For example, ports on the first subsea well component 22 and the second subsea well component 34 coupled to the first connection 24 and the second connection 32 may be horizontal and substantially parallel to the sea floor, which may simplify the overall exemplary subsea well system 20 as compared to systems with vertical connections. Accordingly, to connect the first flowline jumper portion 26 and second flowline jumper portion 30 to the first subsea well component 22 and the second subsea well component 34, a horizontal stroke is used. The expansion joint 28 allows the first flowline jumper portion 26 and the second flowline jumper portion 30 to retract and extend horizontally such that the horizontal stroke is provided to connect to the respective connection ports. For example, the expansion joint 28 may be initially retracted for minimum horizontal length, then once the first connection 24 and the second connection 32 are aligned with the respective ports of the first subsea well component 22 and the second subsea well component 34 the expansion joint 28 is extended to provide the stroke length to make the connections.

The expansion joint 28 is shown at a central portion of the overall jumper assembly between the first flowline jumper portion 26 and the second flowline jumper portion 30. However, it should be understood that embodiments are contemplated in which the expansion joint 28 is disposed at either or both ends of the jumper assembly. For example, the expansion joint 28 may be disposed at any of the first connection 24 or the second connection 32. Further, in some embodiments, a plurality of expansion joints 28 may be included at various positions along the length of the jumper assembly.

FIG. 3 illustrates an exemplary linearly slidable expansion joint 40 relating to some embodiments. The linearly slidable expansion joint 40 includes a first linearly slidable connector 42 and a second linearly slidable connector 44. The first linearly slidable connector 42 may be coupled to a first jumper section 46 of the first flowline jumper portion 26, and the second linearly slidable connector 44 may be coupled to a second jumper section 48 of the second flowline jumper portion 30, as shown. Further, the first linearly slidable connector 42 and the second linearly slidable connector 44 may be fluidly connected such that a fluid flow path is provided between an internal bore of each of the first linearly slidable connector 42 and the second linearly slidable connector 44.

The phrase linearly slidable, as described herein, may refer to the ability of two or more components to translate relative to one another along a linear direction. For example, the first linearly slidable connector 42 may be configured to slide along a linear axis of the first linearly slidable connector 42 relative to the second linearly slidable connector 44.

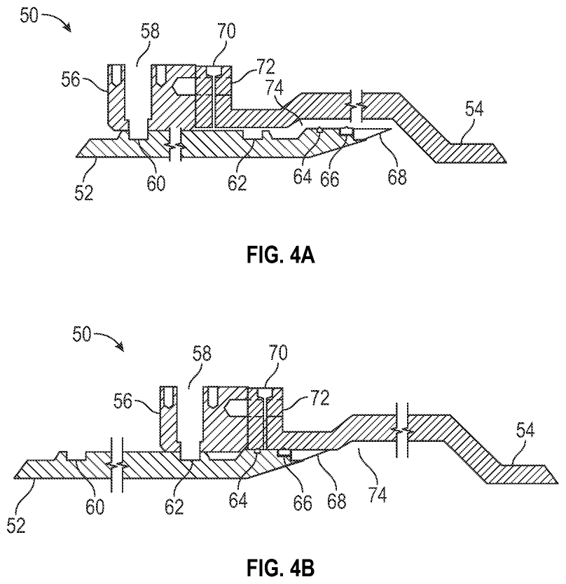

FIG. 4A illustrates an exemplary expansion joint assembly 50 in a retracted position relating to some embodiments. In some embodiments, the expansion joint assembly 50 is disposed at a joint of two or more sections of jumper tubing. The expansion joint assembly 50 includes a first slidable housing 52 and a second slidable housing 54. In some embodiments, the first slidable housing 52 includes a male slidable housing, and the second slidable housing 54 includes a female slidable housing configured to receive at least a portion of the first slidable housing 54.

The exemplary expansion joint assembly 50 further includes a latch assembly 56, as shown, including a spring latch pin receptacle 58 configured to receive a spring-loaded pin or other latching mechanism. The latch assembly 56 may be configured to selectively lock the exemplary expansion joint assembly 50 in place. For example, in some embodiments, a spring-loaded pin may be inserted into the spring latch pin receptacle 58 such that a spring biases the spring-loaded pin into a lock configuration that holds the first slidable housing 52 and second slidable housing 54 in place with respect to one another.

In some embodiments, one or more recessed portions may be included on either of the first slidable housing 52 or the second slidable housing 54 such that the spring-loaded pin may be biased into the recessed portion to thereby lock the exemplary expansion joint assembly 50 into a particular position. For example, a first recessed portion 60 and a second recessed portion 62 may be included on the first slidable housing 52, as shown. In some such embodiments, the spring-loaded pin may be inserted into the first recessed portion 60 to lock the exemplary expansion joint assembly 50 into the retracted position. Similarly, the spring-loaded pin may be inserted into the second recessed portion 62 to lock the exemplary expansion joint assembly 50 into an extended position, as described in further detail below with respect to FIG. 4B. Alternatively, or additionally, in some embodiments, any number of recessed portions are included. For example, a slidable housing may be included that comprises a plurality of notches such that the position may be adjusted between a respective plurality of positions to accommodate various connection configurations.

The exemplary expansion joint assembly 50 further includes one or more sealing elements. For example, in some embodiments, the exemplary expansion joint assembly 50 includes a first seal 64 and a second seal 66, as shown. The first seal 64 may include a non-metallic seal while the second seal 66 may include a metal seal. For example, metal-to-metal seals are contemplated to provide a suitable pressure seal within the exemplary expansion joint assembly 50. Alternatively, or additionally, in some embodiments, a variety of different forms of sealing elements are contemplated, such as, for example, any combination of metallic seals, non-metallic seals, rotary seals, dynamic seals, bonded seals, mechanical seals, and gaskets, as well as other suitable forms of sealing elements not explicitly described herein.

In some embodiments, the exemplary expansion joint assembly 50 further includes a seal retaining element 68, such as a tapered seal retainer, as shown. The seal retaining element 68 may be disposed at a distal end of the first slidable housing 52 and configured to retain either or both of the first seal 64 and the second seal 66. In some embodiments, the seal retaining element 68 is tapered at a similar angle to an angle of the distal end of the first slidable housing 52, as shown.

The exemplary expansion joint assembly 50 further includes a seal test port 70 configured to test an integrity of at least one seal of the exemplary expansion joint assembly 50. For example, the seal test port 70 may be disposed on a portion of the second slidable housing 54. In some embodiments, the seal test port 70 is disposed between the first seal 64 and the second seal 66 to test an integrity of each of the first seal 64 and the second seal 66.

In some embodiments, at least one cavity 72 may be included on at least a portion of the second slidable housing 54, and the latch assembly 56 may be configured to receive one or more fasteners to join the second slidable housing 54 to the latch assembly 56. For example, the cavity 72 may include a threaded hole configured to receive a bolt to join the second slidable housing 54 to the latch assembly 56. Additionally, in some embodiments, any number of cavities 72 may be included at various portions of the exemplary expansion joint assembly 50 to connect two or more components.

In some embodiments, the second slidable housing 54 includes a gap 74 configured to prevent damage to either the first seal 64 or the second seal 66 during translation of the linearly slidable connection. For example, the gap 74 may be disposed on a bottom surface of the second slidable housing 54, as shown, to prevent the second slidable housing 54 from contacting the first slidable housing 52 and at least one seal disposed thereon for at least a portion of the stroke length of the exemplary expansion joint assembly 50.

In some embodiments, one or more extension actuators may be included to provide the extension motion for extending and retracting the exemplary expansion joint assembly 50. For example, a hydraulic piston may be disposed on one of the first slidable housing 52 or the second slidable housing 54 to adjust the position of the slidable housings relative to one another. Additionally, a variety of other forms of extension actuation are contemplated, such as any combination of electric, hydraulic, magnetic, and mechanical actuation, as well as other suitable forms of actuation. Alternatively, in some embodiments, the extension motion may be provided externally by one or more external devices or manually.

FIG. 4B illustrates the exemplary expansion joint assembly 50 in an extended position relating to some embodiments. As shown, the expansion joint assembly 50 is configured to extend longitudinally (i.e., along the length of the respective jumper assembly). Accordingly, the overall length of the expansion joint assembly 50 may be adjusted to provide a connection stroke for one or more ends of a jumper assembly, such as a jumper assembly including the first flowline jumper portion 26, the second flowline jumper portion 30, and the exemplary expansion joint assembly 50. Accordingly, an end of the jumper assembly may be connected to a port of a first subsea component while the exemplary expansion joint assembly 50 is in the retracted position, and then the exemplary expansion joint assembly 50 is extended to provide the stroke length to connect an opposing end of the jumper assembly to a connection port of another subsea component.

In the extended position, the spring-loaded pin of the latch assembly 56 may be configured to protrude into the second recessed portion 62 to thereby lock the exemplary expansion joint assembly 50 into the extended position. Accordingly, in some embodiments, the distance between the first recessed portion 60 and the second recessed portion 62 are selected based on a stroke length of the connection ports of the subsea components. For example, if the stroke length is one foot, the distance between the first recessed portion 60 and the second recessed portion 62 may be one foot such that the jumper assembly is able to be connected to the ports by extending at the expansion joint assembly 50. However, it should be understood that a variety of different stroke lengths and corresponding expansion distances are contemplated such as stroke lengths and distances below one foot and greater than one foot. For example, in some embodiments, a stroke length is used of between about 1 foot to about 2.5 feet. Further, in some embodiments, a stroke length of about 1.66 feet is used. As mentioned above, in some embodiments, the exemplary expansion joint assembly 50 includes a plurality of recessed portions (i.e., notches) that provide a respective plurality of positions for the exemplary expansion joint assembly 50. In some such embodiments, the distances between the notches may be determined based on one or more commonly used stroke lengths of subsea components. Accordingly, a standardized expansion joint assembly that accommodates a variety of different subsea configurations may be provided.

In some embodiments, one or more internal bores are included within each of the first slidable housing 52 and the second slidable housing 54. The internal bores may be configured to be fluidly connected in at least one of the expansion joint assembly 50 positions described above. For example, an internal bore of the first slidable housing 52 may be configured to couple to an internal bore of the second slidable housing 54 while the exemplary expansion joint assembly 50 is in the extended position such that a fluid is able to flow from the first slidable housing 52 to the second slidable housing 54. Alternatively, or additionally, in some embodiments, a plurality of internal bores is included. For example, a multi-bore expansion joint assembly is contemplated that includes a plurality of bores permitting a respective plurality of fluids to flow through the slidable housings 52 and 54. Accordingly, an expansion joint assembly is contemplated that can provide a flow of any combination of gas, chemical-injection, and production fluid simultaneously.

In some embodiments, the latch assembly 56 includes a slanted edge configured to abut against a portion of the first slidable housing 52 in the extended position. For example, the first slidable housing 52 may comprise an opposing slanted edge configured to push up against the slanted edge of the latch assembly 56 to thereby prevent over-extension of the exemplary expansion joint assembly 50. Further, embodiments are contemplated in which a plurality of notches are included for the exemplary expansion joint assembly 50 corresponding to a respective plurality of extension positions. Here, extension may be allowed until the outermost extension past which the slanted edges may be configured to contact one another to prevent over extension past a particular threshold length. For example, in some embodiments, at least one slanted edge is disposed on the first slidable housing 52 configured to prevent linear sliding beyond a predetermined threshold.

In some embodiments, at least a portion of the exemplary expansion joint assembly 50 may be insulated. For example, a thermally insulating cover may be disposed over an outer surface of the exemplary expansion joint assembly 50, such as external to each of the first slidable housing 52 and the second slidable housing 54. The thermal insulating cover may be configured to reduce heat transfer between one or more internal bores of the exemplary expansion joint assembly 50 and the surrounding environment. Any combination of a variety of suitable thermally insulating materials is contemplated for the insulating cover, such as polymers, alloys, rubber, ceramic, and other suitable materials not explicitly described herein. Additionally, in some embodiments, insulation may be applied to other portions of the subsea well system 20. For example, an insulating cover may be placed over any of the first connection 24, the first flowline jumper portion 26, the second flowline jumper portion 30, and the second connection 32.

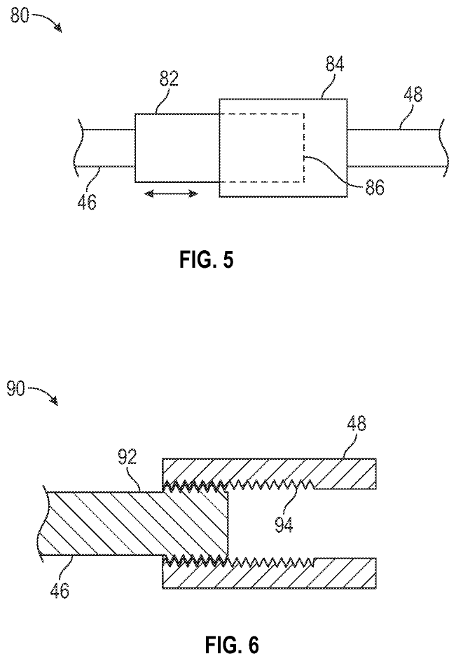

FIG. 5 illustrates an exemplary telescoping expansion joint 80 relating to some embodiments. The telescoping expansion joint 80 may be disposed between the first jumper section 46 and the second jumper section 48, as shown. The telescoping expansion joint 80 comprises two or more telescoping sections such as a first internal telescoping section 82 and an external telescoping section 84. The first internal telescoping section 82 is configured to be at least partially inserted into the second external telescoping section with an internal portion 86 that extends into the external telescoping section 84. Accordingly, the telescoping expansion joint 80 is able to extend by telescoping such that extension is provided by removing a larger portion of the first internal telescoping section 82, and retraction is provided by inserting a larger portion of the first internal telescoping section 82. An internal bore is included within each of the first internal telescoping section 82 and the external telescoping section 84 such that fluid is permitted to flow through the telescoping expansion joint 80.

In some embodiments, one or more extension actuators are included that are configured to provide the telescoping motion. The extension actuators may be placed on one or more of the first internal telescoping section 82 or the external telescoping section 84. Alternatively, in some embodiments, the extension actuators may be disposed on the first jumper section 46, or the second jumper section 48.

In some embodiments, similar to the exemplary expansion joint assembly 50, as described above, the telescoping expansion joint 80 may include any number of seals and latching/locking components. For example, in some embodiments, the telescoping expansion joint 80 includes a dynamic seal disposed within the external telescoping section 84 configured to provide a pressure seal to an internal bore of the external telescoping section 84 and to prevent fluid leakage.

FIG. 6 illustrates an exemplary threaded expansion joint 90 relating to some embodiments. The threaded expansion joint 90 comprises an internal threaded section 92 and an external threaded section 94. In some embodiments, the threaded sections may be integrated directly onto ends of the first jumper section 46 and the second jumper section 48, as shown. For example, a threading may be disposed on an external surface of the first jumper section 46 and a threading may be disposed on an internal surface of the second jumper section 48 such that the first jumper section 46 is configured to thread into the second jumper section 48.

Expansion/retraction of the exemplary threaded expansion joint 90 may be provided through rotational actuation. For example, the exemplary threaded expansion joint 90 may be expanded by rotating the internal threaded section 92 in a first direction and retraction may be provided by rotating the internal threaded section 92 in a second direction opposite the first direction. In some embodiments, a rotational actuator may be included on a portion of the first jumper section 46 or the second jumper section 48 to provide rotation to the internal threaded section 92. In some embodiments, the entire first jumper section 46 may be rotated. Alternatively, in some embodiments, only a portion at the end of the first jumper section 46 is rotated to provide extension/retraction.

In some embodiments, the exemplary threaded expansion joint 90 comprises any combination of seals described herein. For example, a dynamic seal may be included that provides a pressure seal and prevents fluid leakage from an internal bore of the first jumper section 46 and the second jumper section 48.

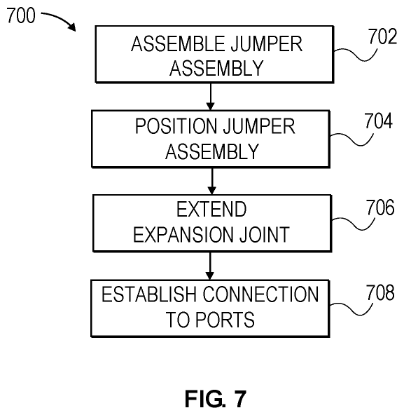

FIG. 7 illustrates an exemplary method of connecting a jumper assembly relating to some embodiments. In some embodiments, any portion of the steps of method 700 described herein may be performed manually by personnel or automatically. Further still, in some embodiments, any number of steps may be omitted, and additional steps may be included.

At step 702, a jumper assembly is assembled. In some embodiments, the jumper assembly comprises any combination of components described above. For example, the jumper assembly may comprise the first flowline jumper portion 26, the expansion joint 28, and the second flowline jumper portion 30. Accordingly, assembly of the jumper assembly may comprise joining the expansion joint expansion joint 28 to each of the first flowline jumper portion 26 and the second flowline jumper portion 30. In some such embodiments, the jumper assembly may be assembled by welding the one or more components together. For example, the expansion joint 28 may be welded to the first flowline jumper portion 26 at a first end and welded to the second flowline jumper portion 30 at a second end. Embodiments are contemplated in which the jumper assembly may be assembled underwater. For example, the components may be transported separately and joined on the seabed. Alternatively, in some embodiments, at least a portion of the jumper assembly may be joined prior to transport to simplify the installation process.

At step 704, the jumper assembly is positioned. For example, the jumper assembly may be positioned within a subsea system between two or more subsea components. In some embodiments, positioning the jumper assembly comprises aligning respective ends of the jumper assembly with ports of the subsea components. Positioning the jumper assembly may further comprise transporting the jumper assembly to the installation destination. In some embodiments, a plurality of jumper assemblies is transported simultaneously. For example, because the jumper assembly may be configured to extend along a single plane, a plurality of jumper assemblies may be stacked together to simplify transport.

At step 706, the expansion joint is extended to increase an overall length of the jumper assembly. In some embodiments, the extension is determined based on a stroke length of the respective ports of the subsea components. A variety of forms of actuation to drive the extension of the expansion joint are contemplated. For example, forms of actuation may include any combination of electrical actuation, mechanical actuation, hydraulic actuation, magnetic actuation, and other forms of actuation not explicitly described herein.

At step 708, a connection to the ports is established at each end of the jumper assembly. In some embodiments, the connection to the ports is established by extending the jumper assembly to provide the stroke length of the connection ports. For example, an extension length of the expansion joint may be approximately equal to a sum of the stroke length of a first connection port and the stroke length of a second connection port. Alternatively, in some embodiments, the extension length is approximately equal to a single stroke length.

Embodiments described above are directed to subsea expansion assemblies, however, it should be understood that similar expansion joints are contemplated for terrestrial operations such as above ground and underground operations to provide selectively extendable connections. Further still, embodiments are contemplated for connecting one or more subsea components with one or more above-ground components or one or more components transported on watercraft.

The following embodiments represent exemplary embodiments of concepts contemplated herein. Any one of the following embodiments may be combined in a multiple dependent manner to depend from one or more other clauses. Further, any combination of dependent embodiments (e.g., clauses that explicitly depend from a previous clause) may be combined while staying within the scope of aspects contemplated herein. The following clauses are exemplary in nature and are not limiting.

Clause 1. An expansion joint for connecting one or more flowline jumper portions of a subsea well system, the expansion joint comprising: one or more linearly slidable connectors configured to linearly adjust a length of the expansion joint, wherein the one or more linearly slidable connectors provide a fluid path between the one or more flowline jumper portions; at least one seal configured to provide a pressure seal within the expansion joint; and a latch device configured to lock the one or more linearly slidable connectors in place. Thus, the illustrative embodiment provides technological improvements over conventional techniques by implementing an expansion joint that provides more efficient mechanisms for establishing subsea connections.

Clause 2. The expansion joint of clause 1, wherein the latch device comprises a spring-loaded latch pin configured to lock in to at least one pin receptacle disposed on the one or more linearly slidable connectors.

Clause 3. The expansion joint of any of clause 1 or 2, wherein the one or more linearly slidable connectors comprises a first pin receptacle and a second pin receptacle disposed in distinct positions on the one or more linearly slidable connectors, and wherein the one or more linearly slidable connectors are configured to linearly slide between a first position and a second position based on the first pin receptacle and the second pin receptacle respectively.

Clause 4. The expansion joint of any of clause 1-3, further comprising at least one slanted edge disposed on the one or more linearly slidable connectors configured to prevent linear sliding of the one or more linearly slidable connectors beyond a predetermined threshold.

Clause 5. The expansion joint of any of clause 1-4, wherein the at least one seal comprises a metal-to-metal seal.

Clause 6. The expansion joint of any of clause 1-5, wherein the at least one seal further comprises a non-metallic seal.

Clause 7. A jumper expansion assembly for connecting a subsea well system, the jumper expansion assembly comprising: a first flowline jumper portion extending longitudinally from a first subsea well system component of the subsea well system; a second flowline jumper portion extending longitudinally from a second subsea well system component of the subsea well system; an expansion joint configured to join the first flowline jumper portion and the second flowline jumper portion, the expansion joint comprising: a linearly slidable connector configured to linearly adjust a length of the expansion joint, wherein the linearly slidable connector provides a fluid path between the first flowline jumper portion and the second flowline jumper portion; and at least one seal configured to provide a pressure seal within the expansion joint. Thus, the illustrative embodiment provides technological improvements over conventional techniques by implementing an expansion joint that provides more efficient mechanisms for establishing subsea connections.

Clause 8. The jumper expansion assembly of clause 7, further comprising: an additional expansion joint configured to join the first flowline jumper portion and the second flowline jumper portion.

Clause 9. The jumper expansion assembly of any of clause 7 or 8, wherein the expansion joint comprises a gap configured to prevent damage to the at least one seal during linear translation of the linearly slidable connector.

Clause 10. The jumper expansion assembly of any of clause 7-9, wherein the expansion joint comprises a predetermined stroke length that is selected based on a combined stroke length of respective connection ports on the first subsea well system component and the second subsea well system component.

Clause 11. The jumper expansion assembly of any of clause 7-10, wherein the expansion joint further comprises: a seal test port disposed on a portion of the expansion joint, the seal test port configured to test an integrity of the at least one seal.

Clause 12. The jumper expansion assembly of any of clause 7-11, wherein each of the first flowline jumper portion and the second flowline jumper portion comprise a flexible pipe.

Clause 13. The jumper expansion assembly of any of clause 7-12, wherein an end of the first flowline jumper portion is welded to the expansion joint and an end of the second flowline jumper portion is welded to the expansion joint.

Clause 14. The jumper expansion assembly of any of clause 7-14, wherein an end of the first flowline jumper portion is removably coupled to the expansion joint and an end of the second flowline jumper portion is removably coupled to the expansion joint.

Clause 15. A subsea well system comprising: a manifold; a well tree assembly; a first flowline jumper portion extending longitudinally from the manifold; a second flowline jumper portion extending longitudinally from the well tree assembly; an expansion joint configured to join the first flowline jumper portion and the second flowline jumper portion, the expansion joint comprising: a linearly slidable connector configured to linearly adjust a length of the expansion joint, wherein the linearly slidable connector provides a fluid path between the first flowline jumper portion and the second flowline jumper portion; and at least one seal configured to provide a pressure seal within the expansion joint. Thus, the illustrative embodiment provides technological improvements over conventional techniques by implementing an expansion joint that provides more efficient mechanisms for establishing subsea connections.

Clause 16. The subsea well system of clause 15, wherein the first flowline jumper portion, the second flowline jumper portion, and the expansion joint are suspended over a sea floor environment between the manifold and the well tree assembly.

Clause 17. The subsea well system of clause 15 or 16, wherein an overall length of the first flowline jumper portion, the second flowline jumper portion, and the expansion joint is between about 50 feet to about 150 feet.

Clause 18. The subsea well system of any of clause 15-17, wherein the first flowline jumper portion is joined to the manifold at a horizontal connection port.

Clause 19. The subsea well system of any of clause 15-18, wherein the first flowline jumper portion, the second flowline jumper portion, and the expansion joint extend along a single plane.

Clause 20. The subsea well system of any of clause 15-19, wherein a stroke length of the expansion joint is selected based on at least one of a first stroke length associated with a first horizontal port of the manifold and a second stroke length associated with a second horizontal port of the well tree assembly.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

What is claimed is:

1. An expansion joint for connecting one or more flowline jumper portions of a subsea well system, the expansion joint comprising:
one or more linearly slidable connectors configured to linearly adjust a length of the expansion joint,
wherein the one or more linearly slidable connectors provide a fluid path between the one or more flowline jumper portions;
at least one seal configured to provide a pressure seal within the expansion joint; and
a latch device configured to lock the one or more linearly slidable connectors in place.

2. The expansion joint of claim 1, wherein the latch device comprises a spring-loaded latch pin configured to lock in to at least one pin receptacle disposed on the one or more linearly slidable connectors.

3. The expansion joint of claim 2, wherein the one or more linearly slidable connectors comprises a first pin receptacle and a second pin receptacle disposed in distinct positions on the one or more linearly slidable connectors, and wherein the one or more linearly slidable connectors are configured to linearly slide between a first position and a second position based on the first pin receptacle and the second pin receptacle respectively.

4. The expansion joint of claim 1, further comprising at least one slanted edge disposed on the one or more linearly slidable connectors configured to prevent linear sliding of the one or more linearly slidable connectors beyond a predetermined threshold.

5. The expansion joint of claim 1, wherein the at least one seal comprises a metal-to-metal seal.

6. The expansion joint of claim 5, wherein the at least one seal further comprises a non-metallic seal.

7. A jumper expansion assembly for connecting a subsea well system, the jumper expansion assembly comprising:
a first flowline jumper portion extending longitudinally from a first subsea well system component of the subsea well system;
a second flowline jumper portion extending longitudinally from a second subsea well system component of the subsea well system;
an expansion joint configured to join the first flowline jumper portion and the second flowline jumper portion, the expansion joint comprising:
a linearly slidable connector configured to linearly adjust a length of the expansion joint,
wherein the linearly slidable connector provides a fluid path between the first flowline jumper portion and the second flowline jumper portion; and
at least one seal configured to provide a pressure seal within the expansion joint.

8. The jumper expansion assembly of claim 7, further comprising:
an additional expansion joint configured to join the first flowline jumper portion and the second flowline jumper portion.

9. The jumper expansion assembly of claim 7, wherein the expansion joint comprises a gap configured to prevent damage to the at least one seal during linear translation of the linearly slidable connector.

10. The jumper expansion assembly of claim 7, wherein the expansion joint comprises a predetermined stroke length that is selected based on a combined stroke length of respective connection ports on the first subsea well system component and the second subsea well system component.

11. The jumper expansion assembly of claim 7, wherein the expansion joint further comprises:
a seal test port disposed on a portion of the expansion joint, the seal test port configured to test an integrity of the at least one seal.

12. The jumper expansion assembly of claim 7, wherein each of the first flowline jumper portion and the second flowline jumper portion comprise a flexible pipe.

13. The jumper expansion assembly of claim 7, wherein an end of the first flowline jumper portion is welded to the expansion joint and an end of the second flowline jumper portion is welded to the expansion joint.

14. The jumper expansion assembly of claim 7, wherein an end of the first flowline jumper portion is removably coupled to the expansion joint and an end of the second flowline jumper portion is removably coupled to the expansion joint.

15. A subsea well system comprising:
a manifold;
a well tree assembly;
a first flowline jumper portion extending longitudinally from the manifold;
a second flowline jumper portion extending longitudinally from the well tree assembly;
an expansion joint configured to join the first flowline jumper portion and the second flowline jumper portion, the expansion joint comprising:
a linearly slidable connector configured to linearly adjust a length of the expansion joint,
wherein the linearly slidable connector provides a fluid path between the first flowline jumper portion and the second flowline jumper portion; and
at least one seal configured to provide a pressure seal within the expansion joint.

16. The subsea well system of claim 15, wherein the first flowline jumper portion, the second flowline jumper portion, and the expansion joint are suspended over a sea floor environment between the manifold and the well tree assembly.

17. The subsea well system of claim 15, wherein an overall length of the first flowline jumper portion, the second flowline jumper portion, and the expansion joint is between about 50 feet to about 150 feet.

18. The subsea well system of claim 15, wherein the first flowline jumper portion is joined to the manifold at a horizontal connection port.

19. The subsea well system of claim 15, wherein the first flowline jumper portion, the second flowline jumper portion, and the expansion joint extend along a single plane.

20. The subsea well system of claim 15, wherein a stroke length of the expansion joint is selected based on at least one of a first stroke length associated with a first horizontal port of the manifold and a second stroke length associated with a second horizontal port of the well tree assembly.
